(19) United States
(12) Patent Application Publication
(10) Pub. No.: US 2025/0217600 A1
(43) Pub. Date: Jul. 3, 2025

(54) SYSTEM AND METHOD FOR GENERATING REVIEW SUMMARIES BASED ON CLASSIFIED TOPICS

(71) Applicant: Shopify Inc., Ottawa (CA)

(72) Inventors: CHUANYE OUYANG, Gaithersburg, MD (US); BENJAMIN LERCHIN, Victoria (CA)

(21) Appl. No.: 18/400,678

(22) Filed: Dec. 29, 2023

(51) Int. Cl. G06F 40/40; G06Q 30/0282

(52) U.S. Cl. CPC G06F 40/40; G06Q 30/0282

(57) ABSTRACT

Products or services may be reviewed by previous users, and an LLM may be to generate a summary review summarizing these reviews. However, LLMs may have difficulty summarizing large amounts of diverse text, and additional instructions or context in an input prompt may guide summarization of these reviews by the LLM. A computer-implemented method may involve: associating reviews with topics; and generating an input prompt for an LLM comprising selected reviews of the reviews and instructing generation of a summary review of the selected reviews. The selected reviews may be selected from amongst the reviews based on the topics associated with the reviews. The method may further involve inputting the input prompt into the LLM and obtaining the summary review as generated by the LLM.

### BACKGROUND

Generative language models may be large neural network predictive models which determine probabilities for a next word conditional on previous or historical words. Large language models (LLMs) are an example of a generative language model. LLMs may be responsive to input prompts including one or more of instructions, context and input data.

### SUMMARY

Websites and other Internet content related to products or services may include reviews left by previous users regarding the products or services. These reviews can provide insight on the user experience with the product or service, including aspects the users enjoyed, issues the users experienced, and whether the users would recommend the product or service to others. However, a particular product or service may be reviewed hundreds or thousands of times by previous users. It may be impractical or inefficient for a provider of the product or service or a potential future user to read every review. To solve this issue, a generative language model (e.g., an LLM) may be used to generate a summary review summarizing the numerous reviews for a particular product or service. The summary review can be provided to the provider or potential further user instead of the hundred or thousands of actual reviews. For example, the LLM may be responsive to an input prompt including instructions of “summarize the following reviews” and input data of an aggregation of reviews (such as “review 1”, “review 2”, “review 3” [ . . . ] “review n” etc.).

However, off-the-shelf (OTS) LLMs (e.g., GPT-4, GPT-3, GPT-3.5, Claude 2) often have difficulty with summarizing large amounts of text or text having diverse content. For example, in response to a simple input prompt to “summarize” reviews, an OTS LLMs may select content from the reviews at random, may inadvertently omit or misrepresent important details within the reviews, or may include irrelevant information not related to the product or service that is the subject of the review (e.g., related to shipping of the product for example). These issues may stem from the training data used to train the LLMs and may also be due to technical limitation of an input prompt limit of such LLMs caused by an underlying size of a position embedding matrix of such LLMs, or an output size of certain transformation layers of such LLMs. Users of such LLM may thus be unable to input all reviews associated with a particular product or service for summarization thereof. Additionally, in situations where the summary review generated by the LLM is of a poor quality (e.g., focused on irrelevant topics or omits relevant topics), users are often unable to determine or understand how or why the LLM produced a particular response.

As a possible solution to the above issues, additional instructions or context may be provided to the LLM in the input prompt in order to improve the quality of a summary generated by the LLM. In this regard, a plurality of reviews related to a particular product may be associated with more than one topic relevant to that particular product (e.g., a plurality of reviews for a shoe product may be related to topics including “material”, “fit”, and “design”), and the more than one topic may be used to guide the LLM's summarization of the set of reviews as described below. In some situations, the topics relevant to a particular product may be known ahead of time (e.g., may be provided by a provider of the product or service). However, in some situations, the topics relevant to a particular product or service may not be known ahead of time. In such situations, one or more clustering processes on the plurality of reviews directed to that particular product or service may be performed in order to determine the topics which are relevant to a particular product or service. In yet other situations, it may be difficult to determine which of the topics (relevant to a particular product or service) a particular review directed to the particular product or service should be classified into. In such situations, one or more review classifiers trained on a review training set of training pairs paring training topic labels with training reviews may be used to generate an output of a topic label in response to an input of a review.

According to one embodiment, a computer-implemented method is provided. The computer-implemented method may include: associating reviews with topics; generating an input prompt for a generative language model, the input prompt comprising selected reviews of the reviews, the selected reviews selected from amongst the reviews based on the topics associated with the reviews and instructing generation of a summary review of the selected reviews; inputting the input prompt into the generative language model; and obtaining, from the generative language model, the summary review as generated by the generative language model.

In some embodiments, associating the reviews with the topics may involve: generating semantic vectors of the reviews; and clustering, using one or more clustering processes, the reviews into topic clusters based on the semantic vectors. The topic clusters may correspond to the topics.

In some embodiments, associating the reviews with the topics may involve classifying, using a topic classifier, the reviews according to the topics.

In some embodiments, the computer-implemented method may further involve training the topic classifier by: creating a topic training set of training pairs, the training pairs paring training topic labels with training reviews. The training topic labels may correspond to the topics; and training the topic classifier using the topic training set.

In some embodiments, the computer-implemented method may further involve generating the training topic labels by: generating semantic vectors for the training reviews; and clustering, using one or more clustering processes, the training reviews into training topic clusters based on the semantic vectors. Each of the training topic clusters may correspond to one of the training topic labels.

In some embodiments, the reviews may be associated with the topics based on text content of the reviews.

In some embodiments, the selected reviews may include reviews associated with one of the topics. The input prompt may further include instructions or context identifying the one of the topics.

In some embodiments, the selected reviews may be selected from amongst the reviews further based on a classification score of the selected reviews relative to the one of the topics.

In some embodiments, the selected reviews may include reviews associated with at least two of the topics. The input prompt may further include instructions or context identifying the at least two of the topics.

In some embodiments, the selected reviews may be selected from amongst the reviews further based on at least one of an averaged classification score or a summed classification score of the reviews relative to the at least two of the topics.

In some embodiments, the selected reviews may include reviews associated with none of the topics. The input prompt may further include instructions or context identifying the topics.

In some embodiments, generating the input prompt may further involve: determining sets of selected reviews of the reviews, wherein each of the sets of selected reviews is associated with a corresponding topic of the topics; and generating input prompts, wherein one input prompt of the input prompts include the set of selected reviews and instructions or context identifying the corresponding topic.

According to another embodiment, a system is provided. The system may include at least one processor and a memory storing processor-executable instructions that, when executed, cause the at least one processor to: associate reviews with topics; generate an input prompt for a generative language model, the input prompt comprising selected reviews of the reviews, the selected reviews selected from amongst the reviews based on the topics associated with the reviews, and instructing generation of a summary review of the selected reviews; input the input prompt into the generative language model; and obtain, from the generative language model, the summary review as generated by the generative language model.

In some embodiments, the processor-executable instructions which cause the at least one processor to associate the reviews with the topics may include processor-executable instructions which cause the at least one processor to: generate semantic vectors of the reviews; and cluster, using one or more clustering processes, the reviews into topic clusters based on the semantic vectors. The topic clusters may correspond to the topics.

In some embodiments, the processor-executable instructions which cause the at least one processor to associate the reviews with the topics may include processor-executable instructions which cause the at least one processor to classify, using a text classifier, the reviews according to the topics.

In some embodiments, the processor-executable instructions may further cause the at least one processor to train the text classifier by causing the at least one processor to: create a topic training set of training pairs, the training pairs paring training topic labels with training reviews, wherein the training topic labels correspond to the topics; and train the text classifier using the topic training set.

In some embodiments, the selected reviews may include reviews associated with one of the topics. The input prompt may further include instructions or context identifying the one of the topics.

In some embodiments, the selected reviews may include reviews associated with at least two of the topics. The input prompt may further include instructions or context identifying the at least two of the topics.

In some embodiments, the selected reviews may include reviews associated with none of the topics. The input prompt may further include instructions or context identifying the topics.

According to another embodiment, a non-transitory computer-readable storage medium is provided. The non-transitory computer-readable storage medium may have stored thereon processor-executable instruction that, when executed, cause at least one processor to: associate reviews with topics; generate an input prompt for a generative language model, the input prompt comprising selected reviews of the reviews, the selected reviews selected from amongst the reviews based on the topics associated with the selected reviews, and instructing generation of a summary review of the selected reviews; input the input prompt into the generative language model; and obtain, from the generative language model, the summary review as generated by the generative language model.

Other aspects and features of the present disclosure will become apparent to those ordinarily skilled in the art upon review of the following description of specific embodiments of the disclosure in conjunction with the accompanying figures.

### BRIEF DESCRIPTION OF DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of a software platform in accordance with one embodiment;

FIG. 4 is an example of content hosted by a content server of the software platform of FIG. 3 in accordance with one embodiment;

FIG. 5 is a schematic of a summary server of the software platform of FIG. 3 in accordance with one embodiment;

FIG. 6 is a flowchart of a determine topics process executed at the summary server of FIG. 5 in accordance with one embodiment;

FIG. 7 depicts a plurality of topic clusters determined by the determine topics process of FIG. 6 for a particular plurality of reviews in accordance with one embodiment;

FIG. 8 depicts a plurality of topic clusters determined by the determine topics process of FIG. 6 for a particular plurality of reviews in accordance with another embodiment;

FIG. 9 is a flowchart of a generate summary process executed at the summary server of FIG. 5 in accordance with one embodiment;

FIG. 10 is a flowchart of computer-implemented method for using a generative language model to generate a summary review based on an input prompt comprising selected reviews of reviews associated with topics, wherein the selected reviews are selected from amongst the reviews based on the topics associated with the reviews executed at the summary server of FIG. 5 in accordance with one embodiment; and

FIG. 11 is a block diagram of a software platform in accordance with another embodiment incorporating an example e-commerce platform.

### DETAILED DESCRIPTION

A generative language model, such as an OTS LLM as described below, may receive an input prompt including input data comprising reviews of a particular product or services and instructions directing the LLM to generate a summary review of the reviews. However, OTS LLMs often have difficulty with summarizing large amounts of text content or text content directed to diverse topics. In response to instructions to “summarize” the reviews, a LLM may select content from the different reviews at random, may inadvertently omit or misrepresent important details within the different reviews, or may include information not relevant to the product or service that is the subject of the reviews (e.g., information related to shipping of the product for example). These issues may stem from the diverse text content of reviews, the training data used to train the LLMs and/or technical limitation of an input prompt limit (aka., context window limit) of such LLMs caused by an underlying size of a position embedding matrix of such LLMs or an output size of certain transformation layers of such LLMs. Users of such LLM are thus unable to input all reviews directed to a particular product or service for summarization thereof. As a result, in situations where the summary review generated by the LLM is of a poor quality (e.g., focused on irrelevant topics or omits relevant topics), users of such LLMs are often unable to determine or understand how or why the LLM produced a particular response.

Embodiments herein relate to providing additional instructions or context in the input prompt to a LLM to improve the quality of a summary review generated by the LLM. In this regard, reviews related to a particular product or service may be associated with one or more topics relevant to that particular product or service. The one or more topics may be provided to the LLM in the input prompt or used to otherwise guide the LLM's summarization of the reviews in a variety of different ways as described below. For example, in some embodiments, the one or more topics may be used to select a subset of the reviews to be included in the input prompt provided to the LLM. In other embodiments, the one or more topics may be included as context in the input prompt provided to the LLM.

In some embodiments, the one or more topics to be associated with the reviews (i.e., topics relevant for a particular product) may be known ahead of time (e.g., may be provided by a provider of the product or service for example). In other embodiments, the one or more topics may not be known and may be determined via one or more clustering processes (e.g., one or more unsupervised clustering processes). Performing such clustering processes may involve generating semantic vectors for each review of the selected reviews using different text embedding processes. The semantic vectors for each review may then be used to cluster reviews of the reviews into at least one cluster using different clustering processes. The number and identity of clusters generated for a particular set of reviews may correspond to the number and identity of relevant topics to be associated with that particular set of reviews. The reviews grouped into a particular cluster by the clustering process may be associated with that a topic represented by the particular cluster (e.g., labelled with a topic label or a topic tag).

In some embodiments, after one or more topics relevant for a particular product or service have been determined (e.g., via the one or more clustering processes) or provided (e.g., via the provider), a review classifier (e.g., a machine learning (ML) model, such as a convolutional neural network or a recurrent neural network) may be trained to label subsequent reviews directed to that particular product or service with different topics of the one or more topics utilizing one or more classification processes (e.g., one o more supervised classification processes). For example, a training set may be generated by the one or more clustering processes. The training set may include (a) the reviews grouped into different clusters and (b) associated topic labels of the cluster(s) that the reviews were grouped into. The review classifier may then be trained using the training set to output one or more topic labels based on an input of a review.

To assist in understanding the present disclosure, some concepts relevant to neural networks and machine learning (ML) are first discussed.

### Neural Networks and Machine Learning

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label), or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

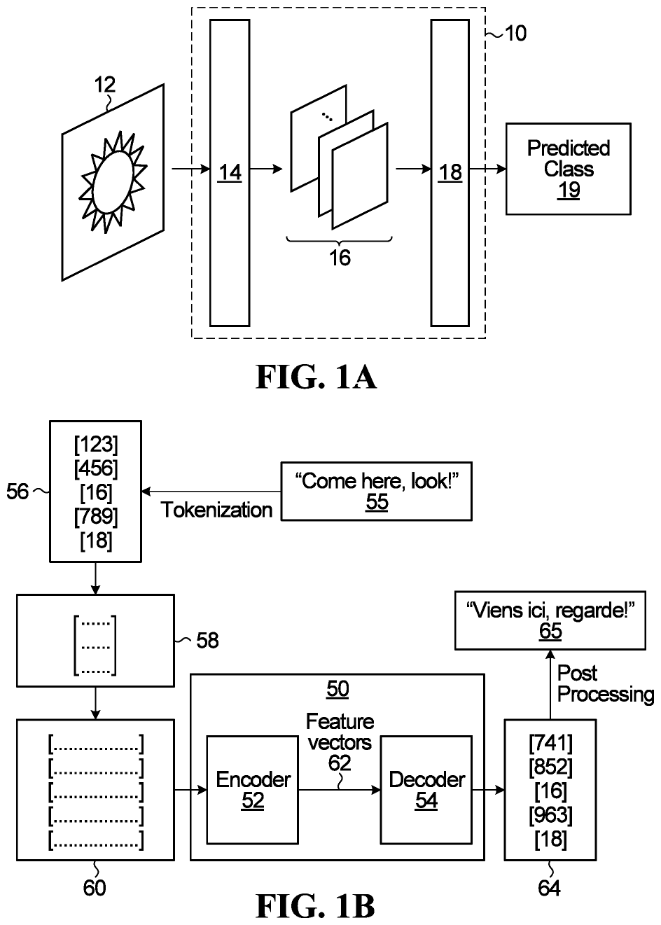

FIG. 1A is a simplified diagram of an example CNN 10, which is an example of a DNN that is commonly used for image processing tasks such as image classification, image analysis, object segmentation, etc. an input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification 19 for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” 55 is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!” 65) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

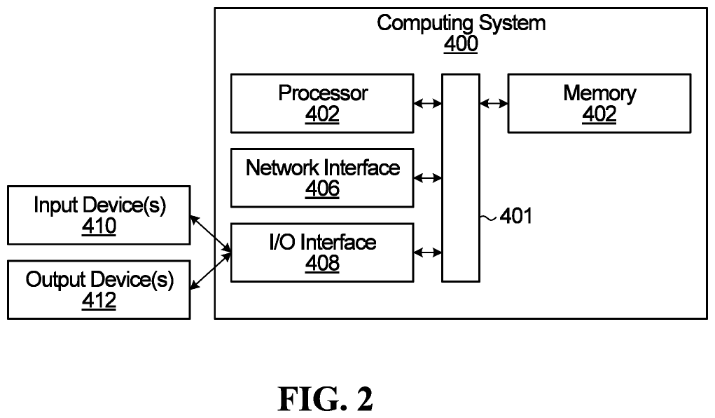

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Software Platform 500

Embodiments herein relate to a generative language model (e.g., an LLM as described above, including standard off-the-shelf (OTS) LLMs such as GPT-4, GPT-3, GPT-3.5, Claude 2) to receive an input prompt comprising selected reviews selected from amongst reviews based on topics associated with the reviews, and to generate a summary review of the selected reviews based on the input prompt. The embodiments described below are presented in the context of a software platform in e-commerce. However, the methods and systems are not limited to e-commerce and are instead applicable to any system in which users leaves reviews for products or services or leaves summaries for any type of content.

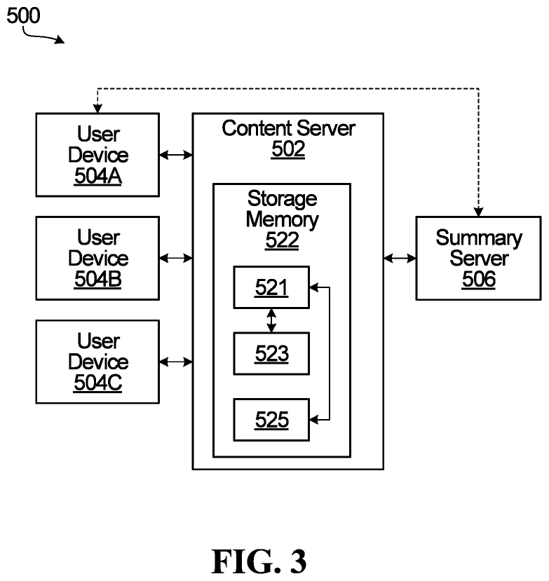

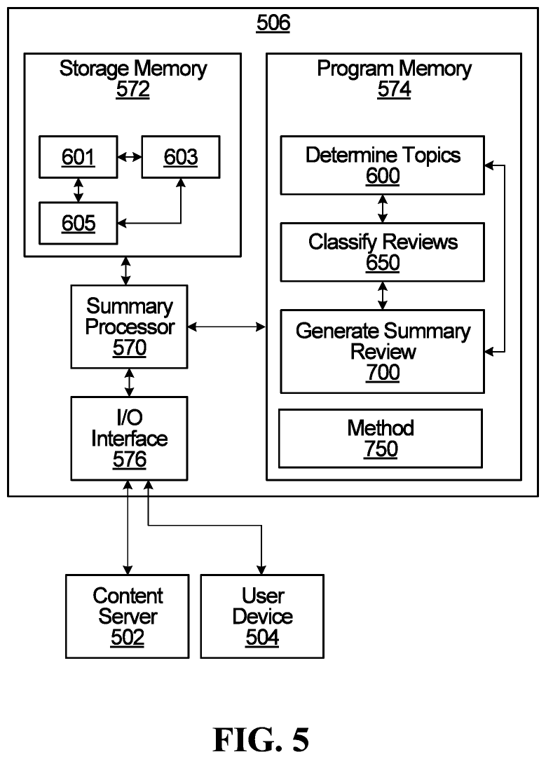

Referring to FIG. 3, a block diagram illustrating a software platform for providing products and/or services in accordance with one embodiment is shown generally at 500. The software platform 500 includes a content server 502, a plurality of client devices 504 (illustrated as 504A-504C in FIG. 5, reference character “504” as used herein may refer to any one client device of the plurality of client devices or the plurality of client devices as a whole), and summary server 506.

The content server 502 may comprise any computer or program that communicates with other computers, programs, or client devices, either in the same computer, over a local network, or over a public network such as the internet. As non-limiting examples, the content server 502 may be application, communication, mail, database, proxy, fax, file, media, web, peer-to-peer, standalone, software, or hardware servers (i.e., server computers) and may use any server format known to one of ordinary skill in the art. The content server 502 may include a processor for performing the operations of the content server 502 (e.g., by executing instructions stored in a program memory of the content server 502), a storage memory 522 for hosting or storing content including within a product or service datastore 521, a review datastore 523 and a topics datastore 525, and a network interface (e.g., a transmitter/receiver with an antenna or a network interface card or a port) for communicating with the summary server 506 and/or the client devices 504. In the embodiment shown in FIG. 3, only a single content server 502 is shown; in other embodiments, more than one content server 502 may be in communication with the summary server 506 and the client devices 504.

The client devices 504 may be, for example, a mobile phone, or a tablet, or a laptop, or a personal computer, etc. A client device 504 may include a processor for performing the operations of the client device 504 (e.g., by executing instructions stored in a program memory of the client device 504), a network interface (e.g., a transmitter/receiver with an antenna or a network interface card or a port) for communicating with the summary server 506 and the content server 502 and a user interface (e.g., keyboard, display, and/or touchscreen). In the embodiment shown in FIG. 3, three client devices 504A, 504B and 504C are shown; in other embodiments, a greater number or a fewer number of client devices 504 may be in communication with the content server 502.

The content server 502 may host or store content associated with products or services provided by a single provider or by multiple providers. The expression “content” as used herein includes any information which can be made available electronically to the client devices 504 and may include websites, webapps, computer applications, mobile applications, multimedia content such as image data, audio data and video data, etc. The expression “products” as used herein refers to any good, article, substance, or information which may be provided to users (e.g., for a cost or for no cost). For example, the product may be an electronic product (e.g., a software application, an electronic book, access to electronic video or audio content) which is delivered electronically to the client devices 504 or may be a physical product which is physically shipped to an address associated with a user of the client device 504. The expression “service” as used herein refers to any action, access or use which may be provided to users (e.g., for cost or for no cost). For example, the service may be an electronic service (e.g., a subscription to a software application, online assistance, etc.) which is provided electronically to a particular client device 504 or may be a physical service which is physically provided to the address associated with the user of the particular client device 504. The client devices 504 may request content hosted or stored by the content server 502 by submitting requests to the content server 502.

The content associated with products or services provided by the content server 502 may include a description of the product or service (e.g., text description, image description, video description, etc.), an option to obtain the product or service (e.g., install, purchase, subscribe), and reviews left by previous users of the product or service. The expression “review” as used herein refers to any comments, assessments, evaluations and/or summaries provided by a user related to the product or service. A particular review may include review content and review metadata. The review content may include the actual comments, assessments, evaluations and/or summaries left by the user. The review content may describe the user experience with the product or service, aspects of the product or service that the user enjoyed, issues with the product or service that the user experienced, and whether the user would recommend the product or service to others. The review content may be in text format, image format or video format. The review metadata may include additional information associated with the review, including without limitation a rating associated with the review, a user account associated with review, an age of the user account, a flag status of the user account, a time and/or date of the review, a flag status associated with the review, etc. A flag status associated with a user account may indicate that the user account entry is a normal account, a duplicate account, a disabled account, a trusted account, an untrusted account, etc. A flag status associated with a review may indicate that the review entry is a normal review, a machine-generated review, a fake review, a duplicate review, etc.

The description of a particular product or service and the plurality of reviews for that particular product or service may be stored by the content server 502 in association with that particular product or service. For example, referring to FIG. 3, the description of a particular product or service may be stored in association with a product or service entry representing that particular product or service in the product or service datastore 521. The review content and the review metadata associated with a particular review of the plurality of reviews may be stored in association with a review entry representing that particular review in the review datastore 523. For example, a particular review entry in the review datastore 523 may include fields associated with content (including the text and/or image forming the review content), a created date, a modified date, and a status for example. A review entry representing a particular review may be associated with a product or service entry representing a particular product or service when the particular review is directed to that particular product or service. A product or service entry in the product or service datastore 521 may be associated with one or more review entries in the review datastore 523 (e.g., the relationship of product or service entry to review entry may be 1:n).

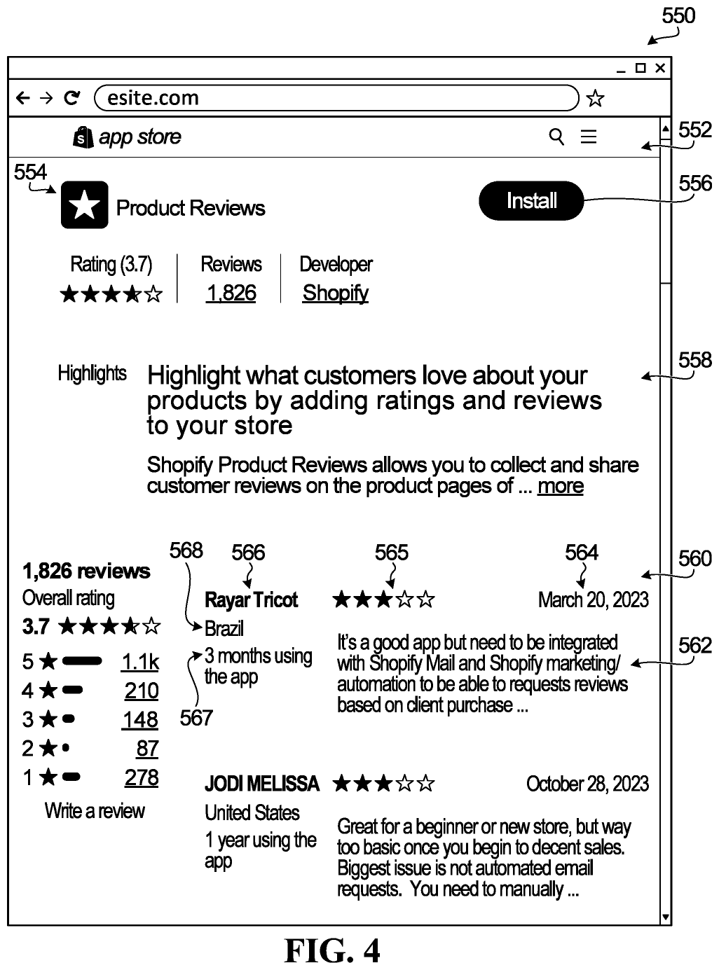

Referring now to FIG. 4, an example of content associated with a particular product a product or service which will be hosted by the content server 502 is generally shown at 550. In embodiment shown, the content 550 is a webpage 552 associated with a software application 554. The webpage 552 includes an install button 556 which may enable a user associated with a particular client device 504 to obtain the software application 554. For example, selecting the install button 556 may cause (or lead to another piece of content for causing) electronic transmission of a data package including the software application 554 from the content server 502 to the client device 504. In the embodiment shown, the webpage 552 further includes a product description 558 and a plurality of reviews 560. The product description 558 may include data from a description field of the product or service entry from the product or service datastore 521 and may generally describe the software application 554, including features, functionality and benefits of the software application 554 for example. The plurality of reviews 560 may include information from review entries from the review datastore 523 and may generally include reviews of the software application 554 left by previous users. Each review of the plurality of reviews 560 include review content 562 comprising comments left by previous users and review metadata comprising, for example, a review date 564, a review rating 565, a user account 566 associated with the review, a time duration 567 that the user account 566 has used the software application 554, and a geographic location 568 of the user associated with the user account 566, and other user information.

However, a particular product or service may be reviewed hundreds or thousands of times by previous users, and a particular product or service entry in the product or service datastore 521 may be associated with hundreds or thousands of review entries of the review datastore 523. It may be impractical or inefficient for the provider of the product or service or a potential future user of the product or service to read every review. In this regard, referring back to FIG. 3, the summary server 506 in communication with the content server 502 and/or the client devices 504 may use a generative language model (e.g., the LLM described above) to generate a summary review for a particular product or service (e.g., the software application 554 shown in FIG. 4) based on an input prompt with input data including different reviews of the plurality of reviews (e.g., the plurality of reviews 560 shown in FIG. 4) directed to that particular product or service. However, as described above, OTS LLMs often have difficulty with summarizing large amounts of text content or text content directed to diverse topics. For example, in response to a simple input prompt to “summarize” the different reviews, an OTS LLM may select content from the different reviews at random, may inadvertently omit or misrepresent important details within the different reviews, or may include irrelevant information not related to the product or service that is the subject of the different reviews (e.g., related to shipping of the product for example). These issues may stem from the training data used to train the LLMs and may also be due to technical limitation of an input prompt limit (aka., context window limit) of such LLMs caused by an underlying size of a position embedding matrix of such LLMs or an output size of certain transformation layers of such LLMs. Users of such LLM are thus unable to input all of the different reviews directed to that particular product or service for summarization thereof. Additionally, in situations where the summary review generated by the LLM is of a poor quality (e.g., focused on irrelevant topics or omits relevant topics), users of such LLMs are often unable to determine or understand how or why the LLM produced a particular response. To increase the relevance of the summary review generated by the LLM, the summary server 506 may also identify relevant topics for the plurality of reviews directed to a particular product and service and select selected reviews from the plurality of reviews as input data in the input prompt based on the relevant topics associated with the plurality of reviews and/or may identification of such relevant topics as instructions or context in the input prompt.

### Summary Server 506

Referring to FIGS. 3 and 5, in the embodiment shown, the summary server 506 is in communication with content server 502 and may also be in communication with one or more of the client devices 504. The summary server 506 may be configured to one or more of: (a) determine or retrieve topics associated with a plurality of reviews; (b) classify a particular review into a topic of the topics, more than one topic of the topics or no topic (e.g., none) of the topics; and (c) generate a summary review of selected reviews of the plurality of reviews, where the selected reviews are selected based on the topics associated with the plurality of reviews. In some embodiments, the summary server 506 is similar to the example computing system 400 described above. Another embodiment of the summary server 506 is shown in FIG. 5; in this embodiment shown, the summary server 506 includes at least one summary processor 570, and a storage memory 572, a program memory 574 and an input/output (I/O) interface 576 all in communication with the summary processor 570. Other embodiments of the summary server 506 may include fewer, additional or alternative components. Additionally, although only a single summary processor 570, a single storage memory 572, a single program memory 574, and a single I/O interface 576 is shown in FIG. 5, other embodiments of the summary server 506 may include more than one of each of these components.

The storage memory 572 stores information received or generated by the summary processor 570 and may generally function as an information or datastore. In the embodiment shown, the storage memory 572 includes a topics datastore 601, a review datastore 603 and a summary review datastore 605; in other embodiments, the storage memory 572 may include fewer, additional or alternative datastores. The program memory 574 stores various blocks of code (alternatively called processor, machine and/or computer executable instructions), including codes for directing the summary processor 570 to perform various processes, such as a determine topics process 600, a classify review process 650, a generate summary review process 700 and a method 750 as described below. The program memory 574 may also store database management system codes for managing the datastores in the storage memory 572. In other embodiments, the program memory 574 may store fewer, additional or alternative codes for directing the summary processor 570 to execute additional or alternative functions. The storage memory 572 and the program memory 574 may each be implemented as one or a combination of a non-transitory computer-readable and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The I/O interface 576 comprises an interface for receiving and transmitting information between the summary server 506 and different systems within the software platform 500, including the content server 502 and/or the client devices 504. For example, the summary server 506 may receive the plurality of reviews (e.g., from the review datastore 523 and including respective review content and respective review metadata), the description of products or services (e.g., from the product or service datastore 521) or a plurality of topics known ahead of time (e.g., from the topics datastore 525) transmitted from the content server 502 or an external source over a network (such as a wireless network or a wired network, a public network or a private network) via the I/O interface 576. As an additional non-limiting example, the content server 502 may transmit the summary review generated based on the plurality of reviews to the content server 502 and/or the client devices 504 via the I/O interface 576. As a further non-nonlimiting example, the summary server 506 also communicate with additional systems over the I/O interface 576, including an external model server (not shown) described below. Such an external model server may have increased processing capacity and computing resources for training and/or fine-tuning various machine learning models, including the generative language models and the review classifier described herein. The I/O interface 576 may include any communication interface which enables the summary processor 570 to communicate with external components, including specialized or standard I/O interface technologies such as channel, port-mapped, asynchronous for example. In some embodiments, the I/O interface 576 may be implemented using a network interface card (NIC), a port, and/or a network socket.

The summary processor 570 may be configured to execute codes stored in the program memory 574, to retrieve information from and store information into the datastores of the storage memory 572, and to receive and transmit information to the content server 502 and/or the client devices 504 over the I/O interface 576, examples of which are described below. In the embodiment shown, the summary processor 570 is a server central processing unit and may be a multi-core processor.

### Determine Topics Process 600

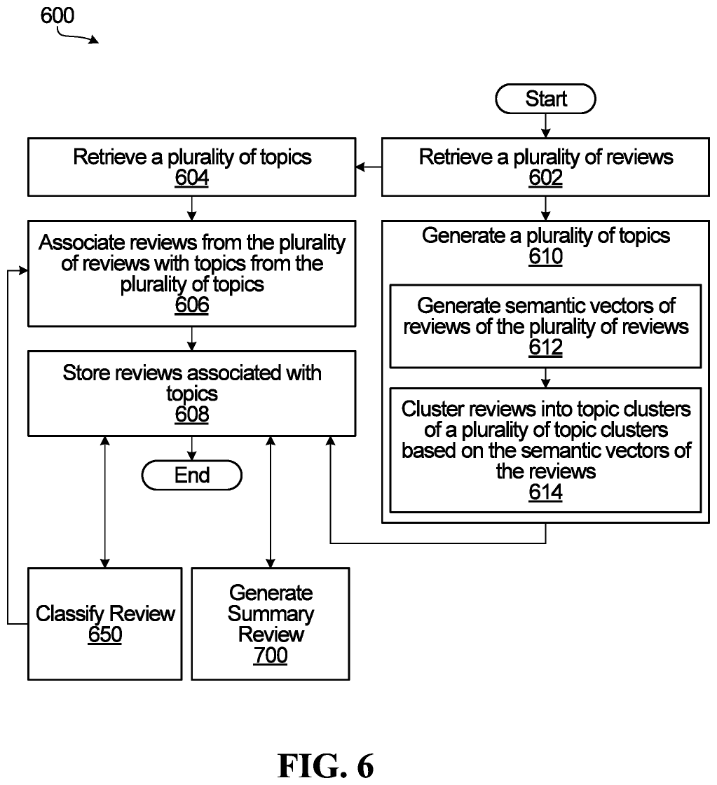

In some embodiments, the summary server 506 may be configured to generate or retrieve topics which may be relevant to a particular product or service (or to a category of products or services or related products or services or all products or services from a particular provider or a particular source) based on a plurality of reviews directed to that particular product. In some embodiments, the summary server 506 may also be configured to determine which reviews of the plurality of reviews should be associated with which topics of the plurality of topics. Referring to FIGS. 5 and 6, a computer-implemented determine topics process for generating or retrieving topics and for determining which review should be associated with which topics is generally shown at 600. As described above, generating or retrieving topics which are relevant to a particular product or service (or a category of products or services or related products or services or all products or services from a particular provider or a particular source) may allow selected reviews to be selected from the plurality of reviews based on the topics. These selected reviews may be fewer and less diverse than the entire plurality of reviews, and a summary review generated based on an input prompt including the selected reviews (rather than the entire plurality of reviews) may be more directed to a relevant topic. Additionally, identifying the topics may allow the topics to be used as instructions or context in an input prompt to guide the LLM to generate a summary review which is more focused on the topics. Utilizing an input prompt including only the selected reviews or including the identified topics may improve a quality of the summary review generated by the LLM.

In the embodiment shown, the determine topics process 600 is performed by the summary processor 570 executing processor, machine and/or computer readable instructions stored in the program memory 574. In other embodiments, the determine topics process 600 may comprise processor, machine and/or computer readable instructions alternatively stored on other non-transitory computer readable storage medium such as a CD-ROM, a floppy disk, a hard drive, a DVD, a Blu-ray disk or another component associated with the summary server 506; in yet other embodiments, the determine topics process 600 and/or parts thereof could alternatively be executed by a device other than the summary processor 570, including for example, by the external model server described above. Further, although the determine topics process 600 in accordance with one embodiment is described with reference to the flowchart illustrated in FIG. 6, other methods of implementing the determine topics process 600 may alternatively be used. For example, the order of execution of the blocks shown in FIG. 6 may be altered, and/or some of the blocks described may be altered, eliminated, or combined.

In the embodiment shown in FIG. 6, the determine topics process 600 begins at block 602, which may include codes directing the summary processor 570 to retrieve a plurality of reviews. In some embodiments, the summary processor 570 may retrieve the plurality of reviews as a plurality of review entries (e.g., including the review content and the review metadata) from the review datastore 523 in the storage memory 522 of the content server 502. Alternatively, in other embodiments, the summary processor 570 may extract the plurality of reviews (e.g., again including the review content and the review metadata) from external sources, including external content not hosted by the content server 502, external websites, external web applications, external multimedia content, etc. As described above, the review content of each review may be in text format, image format or video format. As also described above, the review metadata may include additional information associated with the review, including without limitation the user account associated with review, the age of the user account, the flag status of the user account, the time and/or date of the review, the flag status of the review, etc.

In some embodiments, the plurality of reviews retrieved by the summary processor 570 at block 602 may comprise a plurality of reviews associated with a single product or service. For example, in embodiments where the plurality of reviews comprise review entries retrieved from the review datastore 523, the retrieved review entries may be associated with a same product or service identifier (which may identify a single product or service entry from the product or service datastore 521). As an additional example, in embodiments where the plurality of reviews comprise reviews extracted from an external source, the extracted reviews may be extracted from a same piece of external content (e.g., a same webpage, a same web application, a same piece of multimedia content, etc.). In other embodiments, the plurality of reviews retrieved at block 602 may comprise a plurality of reviews associated with more than one product or service, such as products or services from a category of product or service (e.g., software applications, books, pet food, cleaning products, furniture, musical instruments etc.) and/or a plurality of related products or services (e.g., physical books, electronic books and audiobooks; video streaming subscription services and game subscription services, etc.). For example, in embodiments where the plurality of reviews comprise review entries retrieved from the review datastore 523, the retrieved review entries may be associated with more than one product or service identifier and/or one or more category identifiers. As an additional example, in embodiments where the plurality of reviews comprise reviews extracted from an external source, the extracted reviews may comprise reviews extracted from more than one piece of external content (such as different webpages provided by a same external source, different webpages falling within a particular category, etc.). In yet other embodiments, the plurality of reviews retrieved at block 602 may comprise all possible reviews from a particular provider or from a particular source. For example, in embodiments where the plurality of reviews comprise review entries retrieved from the review datastore 523, the retrieved review entries may comprise every review entry in the review datastore 523. As an additional example, in embodiments where the plurality of reviews comprise reviews extracted from an external source, the extracted reviews may comprise all reviews extracted from all content hosted on a particular e-commerce platform.

In some embodiments, the determine topics process 600 may proceed to block 604, which may include codes directing the summary processor 570 to retrieve a plurality of topics associated with the plurality of reviews retrieved at block 602. In such embodiments, the plurality of topics may be topics known to be relevant for a particular product or service (or for a particular category of products or services or particular related products or services or all products or services from a particular provider or a particular source). In such embodiments, the topics known to be relevant may be provided by a provider of the particular product or service. For example, a provider of a particular running shoe product may know that “material”, “fit”, and “design” are topics known to be relevant for that running shoe product; a provider of another shoe product may know that “material”, “arch support” and “durability” are topics known to be relevant for that other shoe product. As an alternative example, a provider of a particular software product may know that “integration with merchant website”, “cost”, “features” and “user interface” are topics known to be relevant for that particular software product.

In some embodiments, the topics known to be relevant for a particular product or service may be stored with a product or service entry in the product or service datastore 521 of the content server 502. In other embodiments, different providers of similar products may indicate that similar topics are relevant to their products or services (e.g., the “material” topic for different shoe products as described above) and the storage memory 522 of the content server 502 may also include the topics datastore 525 including different topic entries that can be associated with different product or service entries of the product or service datastore 521. One or more product or service entries in the product or service datastore 521 may be associated with one or more topic entries in the topics datastore 525 (e.g., the relationship of product or service entry to topic entry may be n:n). Block 604 may direct the summary processor 570 to retrieve the plurality of topics (e.g., product or service entries from the product or service datastore 521 or topic entries from the topics datastore 525) based on the plurality of reviews retrieved at block 602. For example, as described above, the plurality of reviews may be associated with one or more products or service entries from the product or service datastore 521; block 604 may direct the summary processor 570 to retrieve topics stored in those product or service entries or topics stored in topic entries associated with those product or service entries.

Additionally, in some embodiments, the topics known to be relevant for a particular product or service may have been previously determined for that particular product or service (e.g., through a previous iteration of block 610 as described below), or may have been determined for a particular category of product or service, for a plurality of products or services which are related or linked, for a plurality of products or services which are provided by the same provider or for a same source, etc. In such embodiments, the topics known to be relevant for a particular product or service may be stored in the topics datastore 601 or the review datastore 603 of the summary server 506. Additionally, in some embodiments, the topics known to be relevant for one product or service falling within a particular category may be expanded to be applied for other products or services within that particular category or all products or services within that particular category.

The determine topics process 600 then proceed to block 606, which may include codes directing the summary processor 570 to determine which reviews from the plurality of reviews retrieved at block 602 should be associated with which topics from the plurality of topics retrieved at block 604 (or generated at block 610 as described below). For example, block 606 may direct the summary processor 570 to analyze the review content and/or the review metadata associated with the plurality of reviews for keywords or keydata associated with one or more topic of the plurality of topics. Using shoe product examples described above, keywords associated with the “material” topic may include “material”, “leather”, “foam” “light”, “heavy”, “hot” and “grip”; keywords associated with the “fit” topic may include “fit”, “wide”, “narrow”, “size up”, “size down”, “true to size”, “pinch”, “loose” and “comfortable”; keywords associated with the “design” topic may include “cute”, “colour”, “fashionable”, and “style”. If there is a keyword or keydata associated with one topic in the review content and/or review metadata of a particular review, then that particular review may be associated with that one topic and may be associated with a topic label of that topic. Using the shoe product examples above, if a particular review has review content of: “The shoe fits true to size”, the particular review may be associated with the “fit” topic (keywords “fit” and “true to size”) and may be labeled with a “fit” topic label. In some embodiments, there may be keywords or keydata associated with more than one topic in a particular review, and that particular review may be associated with more than one topic and more than one topic label. Using the shoe product examples above, if a particular review has review content of: “The shoe fits true to size and is very comfortable, and the colour way is very unique”, the particular review may be associated with both the “fit” topic and the “design” topic (keywords “fit”, “true to size”, “comfortable” and “colour”) and may be labeled with both the “fit” topic label and a “design” topic label. In some other embodiments, a particular review ay not include any keywords or keydata associated with the plurality of topics retrieved at block 604. Continuing to use the shoe product examples above, if a particular review has review content of: “The delivery process was very frustrating”, the particular review may not include any keywords associated with the topics relevant for the running shoe product and may be labelled with the “no-topic” label.

In some embodiments, block 606 may also direct the summary processor 570 to generate a classification score for a review which associated with a particular topic, based on how relevant that review is to the particular topic. For example, a review including a greater number of keywords or keydata of a particular topic may have a higher classification score (e.g., more relevant to that particular topic) than a review including a fewer number of the keywords or keydata of the particular topic. Using the shoe product examples above, a first review having review content of: “The shoe fits true to size” may have a lower classification score for the “fit” topic than a second review having the review content of: “The shoe fits wide, but is very comfortable due to the foam support”, as the second review may have more keywords of the “fit” topic. Block 606 may also direct the summary processor 570 to generate more than one classification score for a particular review associated with more than one topic, based on how relevant that review is to each topic. For example, a review may include a large number of keywords or keydata of a first topic and may include a lower number of keywords or keydata of a second topic; the review may be associated with a high classification score for the first topic (e.g., more relevant to the first topic) and a low classification score for the second topic (e.g., less relevant to the second topic). Continuing to use the shoe product examples above, the particular review having the review content of: “The shoe fits true to size and is very comfortable, and the colour way is very unique”, may have a high classification score with “fit” topic and a lower classification score for the “design” topic as the particular review includes more keywords of the “fit” topic.

In some embodiments, block 606 may direct the summary processor 570 to utilize the classify review process 650 and the review classifier to determine which reviews from the plurality of reviews retrieved at block 602 should be associated with which topics from the plurality of topics retrieved at block 604 and to determine classification scores of different reviews for different associated topics as described below.

The determine topics process 600 may then proceed to block 608, which may include codes directing the summary processor 570 to store reviews of the plurality of reviews retrieved at block 602 associated with the “no topic” label, one topic label or more than one topic label based on the determination at block 606 for later use with the classify review process 650 and/or the generate summary review process 700 as described below. For example, block 608 may direct the processor 570 to store the plurality of topics retrieved at block 604 as topic entries in the topics datastore 601 (in the summary server 506) and the plurality of reviews retrieved at block 602 as review entries in the review datastore 603 (in the summary server 506). Associations between the topic entries and the review entries may be based on the determination at block 606. The determine topics process 600 may then end.

However, referring back to block 602, in some embodiments, the summary server 506 may not be able to retrieve the plurality of topics which are relevant to a particular product or service (or to a particular category of products or services or particular related products or services or all products or services from a particular provider or a particular source). For example, the plurality of topics may not be known ahead of time or the plurality of topics which are relevant to the particular product or service may evolve based on user experience. In such embodiments, the determine topics process 600 may instead proceed to block 610, which may include codes directing the summary processor 570 to generate a plurality of topics which may be relevant to a particular product or service (or to a particular category of products or services or particular related products or services or all products or services from a particular provider or a particular source) based on the plurality of reviews which are directed to that particular product or service (e.g., retrieved at block 602).

For example, block 610 may include subblock 612, which may include codes directing the summary processor 570 to generate semantic vectors for the review content of each review of the plurality of reviews retrieved at block 602. The semantic vectors may be generated using text embedding processes and models known to one of ordinary skill in the art. For example, subblock 612 may direct the summary processor 570 to perform a bag-of-words text embedding to generate the semantic vectors for the review content of each review, which may involve determining occurrence of different words in all reviews of the plurality of reviews (i.e., review corpus) to determine a corpus vocabulary and then scoring the words in each review based on the review vocabulary (e.g., using Boolean values of presence or absence of different words in a particular review; counting occurrence of different words in the review; counting a frequency that each word appears in a document; tf-idf, etc.) to generate a semantic vector for each review. Alternatively or additionally, subblock 612 may direct the summary processor 570 to perform NPL model-based text embedding to generate the semantic vectors for the review content of each review, which may involve processing the review (in some embodiments, in combination with processing the plurality of reviews) using a language embedding model (e.g., doc2vec, SBERT, text-embedding-ada-002 etc.).

Block 610 may then proceed to subblock 614, which may include codes directing the summary processor 570 to cluster the plurality of reviews into a plurality of topic clusters based on the semantic vectors generated for the plurality of reviews at subblock 612. The plurality of reviews may be clustered into the plurality of topic clusters using at least one clustering process known to one of ordinary skill in the art, including without limitation K-means clustering, density-based spatial clustering of applications with noise (DBSCAN), hierarchal clustering, latent Dirichlet allocation, Louvain community detection etc. At least some of the clustering processes may be unsupervised clustering processes, and may generate the plurality of topic clusters using the semantic vectors generated for the plurality of reviews without input of identity of the plurality of topic clusters, number of the plurality of topic clusters or size of (e.g., number of reviews within) each topic cluster. The different topic clusters generated by the at least one clustering process may correspond to different topics to be associated with the plurality of reviews retrieved at block 602 and relevant for the particular product or service (or for a particular category of products or services or particular related products or services or all products or services from a particular provider or a particular source) that the plurality of reviews is directed to. The number and identity of topic clusters generated for the plurality of reviews may correspond to the number and identity of topics to be associated with that plurality of reviews.

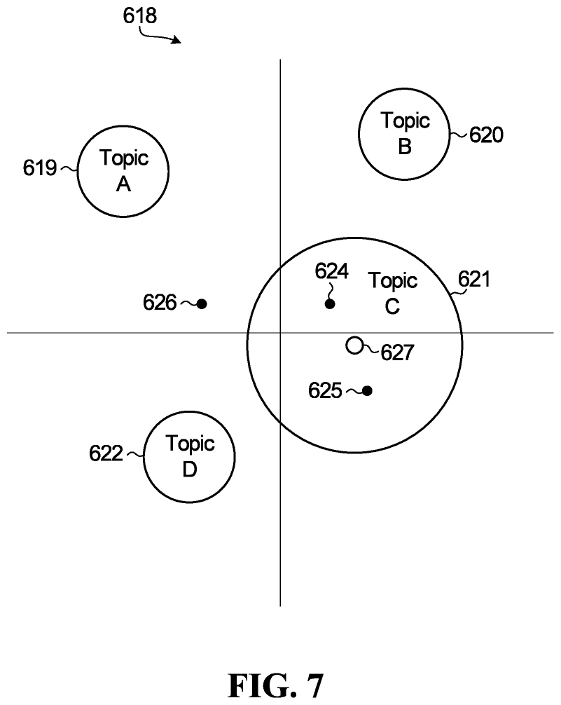

For example, FIG. 7 illustrates different topic clusters generated after subblock 614 in accordance with one embodiment at 618. In this embodiment, four different topic clusters “topic A” cluster 619, “topic B” cluster 620, “topic C” cluster 621 and “topic D” cluster 622 may be generated by at least one clustering process performed on the semantic vectors of the plurality of reviews retrieved at 602. Utilizing the shoe product examples described above, the plurality of reviews retrieved at 602 may be directed to the running shoe product. Topic A cluster 619 may correspond to the “material” topic generated based on reviews which discuss materials of the running shoe product, the topic B cluster 620 may correspond to the “fit” topic generated based on reviews which discuss fit of the running shoe product, the topic C cluster 621 may correspond to the “design” topic generated based on reviews which discuss aesthetic qualities and fashion forwardness of the running shoe product, and the topic D cluster 622 may correspond to a new “use” topic generated based on reviews which discuss use of the shoe product (e.g., road running, trail running, hiking, running on uneven surfaces, etc.). The topic D cluster 622 may be a topic relevant to the running shoe product which was not known ahead of time, or may be a topic relevant to the running shoe product which evolved from user's using the running shoe product.

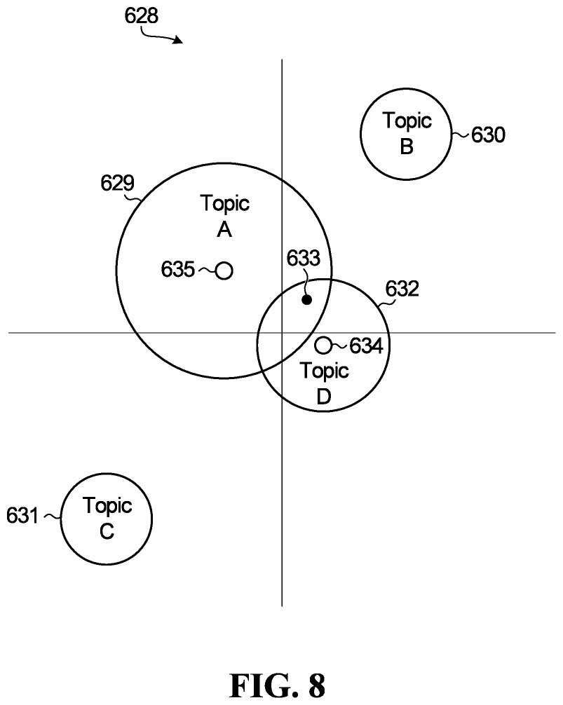

As another example, FIG. 8 illustrates different topic clusters generated after subblock 614 in accordance with another embodiment at 628, after subblock 614. In this embodiment, four different topic clusters “topic A” cluster 629, “topic B” cluster 630, “topic C” cluster 631 and “topic D” cluster 632 be generated by at least one clustering process performed on the semantic vectors of the plurality of reviews retrieved at 602. Continuing to utilize the shoe product examples described above, the plurality of reviews retrieved at 602 may relate to the running shoe product, topic A 629 may correspond to the “material” topic, topic B 620 may correspond to the “fit” topic, topic C 621 may correspond to the “design” topic, and topic D 622 may correspond to the “use” topic. Some topic clusters may overlap when reviews used to generate the topic clusters can be classified into both topic clusters. For example, topic A cluster 629 corresponding to the “material” topic may overlap topic D cluster 632 corresponding to the “use” topic, as some reviews (e.g., review 633) of the plurality of reviews retrieved at block 602 may discuss both material of the running shoe product and use of the running shoe product. For example, the review 633 may be review content of: “I've done a lot of trail running with these in Montana. These feel like a cross between a road running shoe and a trail shoe. Good grip and hasn't broken down after lots of use. Definitely a break in period, specifically with the tongue of the shoe—it's very rigid and not very comfortable.”, where discussion of trail running and road running classifies the review 633 into topic D 632 but discussion of grip and stiffness of the tongue classifies the review 633 into topic A 629.

Some reviews may be classified into one topic cluster (e.g., reviews 624 and 625 classified into topic C cluster 621 shown in FIG. 7) based on the semantic vectors generated for such reviews, and reviews which are classified into one topic cluster may be associated with a topic label of that one topic cluster. For example, both the review 624 and the review 625 may be associated with a “material” topic label. Some reviews may be classified into more than one topic cluster (e.g., the review 633 classified into topic A cluster 629 and topic D cluster 632 shown in FIG. 8) based on the semantic vectors generated for such reviews, and reviews which are classified into multiple topic clusters may be associated with topic labels corresponding to those multiple topic clusters. For example, the review 633 may be associated with both a “material” topic label and a “use” topic label. Some reviews may not be classified into any topic cluster (e.g., the review 626 shown in FIG. 7) based on the semantic vectors generated for such reviews, and reviews which are not classified into any topic cluster may not be associated with any topic labels or may be associated with a “no-topic” label. For example, the review 626 may be associated with a “no-topic” label. Both soft clustering processes, where a particular review can be classified into multiple topic clusters (e.g., the review 633 classified into both topic A cluster 629 and topic D cluster 632 as shown in FIG. 8), and hard clustering processes, whereby a particular review can only be associated with a single topic, (e.g., the reviews 624 and 625 classified into a single topic C cluster), may be used.

Subblock 614 may also be used to generate the classification score for a review which is classified into a particular topic cluster. For example, the classification score may correspond to a distance between a review classified into a particular topic cluster and a centre of that particular topic cluster. The distance may be represented by a distance score generated using different cluster scoring methods (which generally consider both intra-cluster distance and inter-cluster distance) known to one of ordinary skill in the art, including without limitation a Silhouette coefficient, a Rand index, mutual information score, a Calinski-Harabasz index, or a Davies-Bouldin index. The distance score may indicate that some reviews are closer to the centre of the topic cluster than other reviews. For example, the distance score for the reviews 625 and 624 show in FIG. 7 may indicate that the review 625 is close to a topic C cluster centre 627 (e.g., low distance score corresponding to a high classification score) and the review 624 may be further from the topic C cluster centre 627 (e.g., high distance score corresponding to a low classification score). The review 625 may thus be more relevant to the topic C cluster 621 corresponding to the “design” topic than the review 624. A review classified into one or more topic clusters may also be associated with multiple distance scores corresponding to respective distances between the review and a centre of each topic cluster of the one or more topic clusters. For example, the distance scores for the review 633 show in FIG. 8 may indicate that the review 633 is closer to a topic D cluster centre 634 (e.g., low distance score corresponding to a high classification score) and further from the topic A cluster centre 635 (e.g., high distance score corresponding to a low classification score). The review 633 may thus be more relevant to the topic D cluster 632 corresponding to the “use” topic than to the topic A cluster 629 corresponding to the “material” topic.

Accordingly, block 610 (and particularly subblock 614) may be used to simultaneously and automatically (a) generate the plurality of topics to be associated with the plurality of reviews retrieved at block 602 (similar to block 604) and relevant for the particular product or service (or for a particular category of products or services or particular related products or services or all products or services from a particular provider or a particular source) that the plurality of reviews is directed to by generating a plurality of topic clusters using semantic vectors of the plurality of reviews; (b) determine which reviews from the plurality of reviews retrieved at block 602 should be associated with which topics from the plurality of topics (similar to block 606) by determining which topic cluster(s) (of the plurality of topic clusters) a particular review should be classified into and associating that particular review with appropriate topic labels based on that topic cluster; and (c) generate a classification score for a review associated with a particular topic (again similar to block 606) by generating distance scores based on a distance of a particular review to a centre of a topic cluster that the particular review has been classified into. This automatic generation of a plurality of topics which may be relevant for a particular service or product (or for a particular category of products or services or particular related products or services or all products or services from a particular provider or a particular source) and automatic determination of which reviews should be associated with which topics allows identification of topics which are not initially known to be relevant and streamlines and automates the selection of reviews for inclusion in an input prompt based on the topics and the identification of the topics in input prompts. Additionally, in some embodiments, the reviews which are labelled with the “no-topic” label may be used to evolve and improve the topics which are relevant to a particular product or service (or to a particular category of products or services or particular related products or services or all products or services from a particular provider or a particular source) on an ongoing basis, as block 610 may further specifically be performed on the reviews which are labelled with the “no-topic” label to generate topic clusters and to generate other potentially relevant topics.

The determine topics process 600 may then proceed to back to block 608, which may include codes directing the summary processor 570 to store reviews of the plurality of reviews retrieved at block 602 associated with the “no-topic” label (if the corresponding review has been not been classified into any topic clusters at subblock 614), one topic label (if the corresponding review has been classified into one topic cluster and thus associated with one topic label at subblock 614) or more than one topic label (if the corresponding review has been classified into more than one topic cluster and thus associated with more than one topic label at subblock 614) based on the plurality of topic clusters generated at subblock 614 for later use with the classify review process 650 and/or the generate summary review process 700 as described below. For example, block 608 may direct the processor 570 to store the plurality of topic clusters generated at subblock 614 as topic entries in the topics datastore 601 (in the summary server 506) and the plurality of reviews retrieved at block 602 as review entries in the review datastore 603 (again in the summary server 506). Associations between the topic entries and the review entries may be based on which reviews are classified into which topic clusters of the plurality of topic clusters generated at subblock 614. The determine topics process 600 may then end.

### Classify Review Process 650

In some embodiments, the summary server 506 may also be configured to classify additional reviews (in some embodiments, separate or different reviews from the plurality of reviews retrieved at block 602 of the determine topics process 600) into the plurality of topics relevant to a particular product or service (or to a category of products or services or related products or services or all products or services from a particular provider or a particular source). Referring to FIGS. 5 and 6, a computer-implemented classify reviews process for classifying additional reviews into a plurality of topics is shown at 650. Subsequent classification of additional reviews directed to a particular product or service (or to a category of products or services or related products or services or all products or services from a particular provider or a particular source) into the plurality of topics relevant to that particular product or service allows the additional reviews to be associated with the plurality of topics. This association may allow the additional reviews to be selected based on the plurality of topics and may allow the additional reviews to be included in an input prompt identifying topics of the plurality of topics. Generating this association may thus also improve a quality of a summary review generated by the LLM using an input prompt including the additional reviews.

In the embodiment shown, the classify review process 650 is performed by the summary processor 570 executing processor, machine and/or computer readable instructions stored in the program memory 574. In other embodiments, the classify review process 650 may comprise processor, machine and/or computer readable instructions alternatively stored on other non-transitory computer readable storage medium such as a CD-ROM, a floppy disk, a hard drive, a DVD, a Blu-ray disk or another component associated with the summary server 506; in yet other embodiments, the classify review process 650 and/or parts thereof could alternatively be executed by a device other than the summary processor 570, including for example, by the external model server.

The classify review process 650 may include codes directing the summary processor 570 to classify additional reviews associated with a particular product or service (or with a category of products or services or related products or services or all products or services from a particular provider or a particular source) into a plurality of topics relevant to that particular product or service based on the review content and/or the review metadata associated with the additional reviews. The plurality of topics may be retrieved from a provider of the particular product or service and may be retrieved at block 604 and stored at block 608 of the determine topics process 600 as described above. In other embodiments, the plurality of topics may be determined by processing the plurality of reviews for that particular product or service using at least one clustering process and may be generated at block 610 and stored at block 608 of the determine topics process 600 as described above.

For example, in some embodiments, the classify review process 650 may direct the summary processor 570 to classify the additional reviews into the plurality of topics by determing whether the additional reviews include keywords or keydata of different topics of the plurality of topics. For example, continuing to use the shoe product examples described above, reviews of the additional reviews may be classified into a “material” topic when the review content and/or the review metadata of the reviews include keywords such as “material”, “leather”, “foam” “light”, “heavy”, “hot” and “grip”; into a “fit” topic when the review includes keywords such as “wide”, “narrow”, “size up”, “size down”, “true to size”, “pinch”, “loose” and “comfortable”; and a “design” topic when the review includes keywords such as “cute”, “colour”, “fashionable”, and “style”.

In other embodiments, the classify review process 650 may direct the summary processor 570 to classify the additional reviews into the plurality of topics using a review classifier. The review classifier may be a ML model trained by inputting training pairs of training reviews which are ground labelled with training topic labels (e.g., corresponding to the plurality of topics retrieved at block 604 or generated at block 610 of the determine topics process 600), to iteratively generate and optimize coefficients which enable the review classifier to generate an output of a topic label based on an input of a review. In some embodiments, the review classifier may also be configured to generate a classification score indicating a confidence level that the outputted topic label should be associated with the inputted review. The classification score may be different classification scores for assessing a quality of a prediction generated by a ML model known to one of ordinary skill in the art, and may include without limitation balanced accuracy, Cohen's kappa, confusion matrix, average hinge loss, Matthew's correlation coefficient, top-k accuracy classification score, etc.

The review classifier may be trained on the external model server and may be locally stored in the storage memory 572 of the summary server 506. The training pairs of training reviews paired with training topic labels may form a topic training dataset. The training pairs of training reviews paired with training topic labels may be generated using the determine topics process 600 described above. For example, in some embodiments, the training reviews may comprise the plurality of reviews retrieved by summary processor 570 at block 602; the training topic labels may correspond to the plurality of topics retrieved by the summary processor 570 at block 604; and the pairing between the training topic labels and corresponding ones of the training reviews may be based on the determination performed at block 606 (namely, determination of which reviews from the plurality of reviews should be associated with which topics from the plurality of topics) and/or the association between topic entries and review entries stored in the storage memory 572 of the summary server 506 at block 608. In other embodiments, the training reviews may comprise the plurality of reviews retrieved by summary processor 570 at block 602; the training labels may correspond to a number and identity of the plurality of topic clusters generated using semantic vectors of the plurality of reviews at subblock 614; and the pairing between the training topic labels and corresponding ones of the training reviews may be based on which topic cluster(s) a particular review is classified into at subblock 614 and/or the association between topic entries and review entries stored in the storage memory 572 of the summary processor 570 at block 608. This may allow block 610 (and particularly subblock 614) to be used to further simultaneously generate the topics training dataset including the training pairs of training reviews paired with training topic labels by generating the plurality of topic clusters using the plurality of reviews. In this regard, clustering the semantic vectors of the plurality of reviews using the at least one clustering process inherently involves both (a) generating the plurality of topics (e.g., the training topic labels) relevant to the plurality of reviews by generating the plurality of topic clusters; and (b) determining the topic(s) of the plurality of topics that a particular review of a plurality of reviews should be associated with (e.g., the pairing between the training topic labels and the training reviews) by clustering reviews into the plurality of topic clusters.

In some embodiments, the classification of the additional reviews into the plurality of topics performed by the classify review process 650 may be provided to the determine topics process 600, and may function as the determination of which reviews from the plurality of reviews should be associated with which topics from the plurality of topics performed at block 606.

### Generate Summary Review Process 700

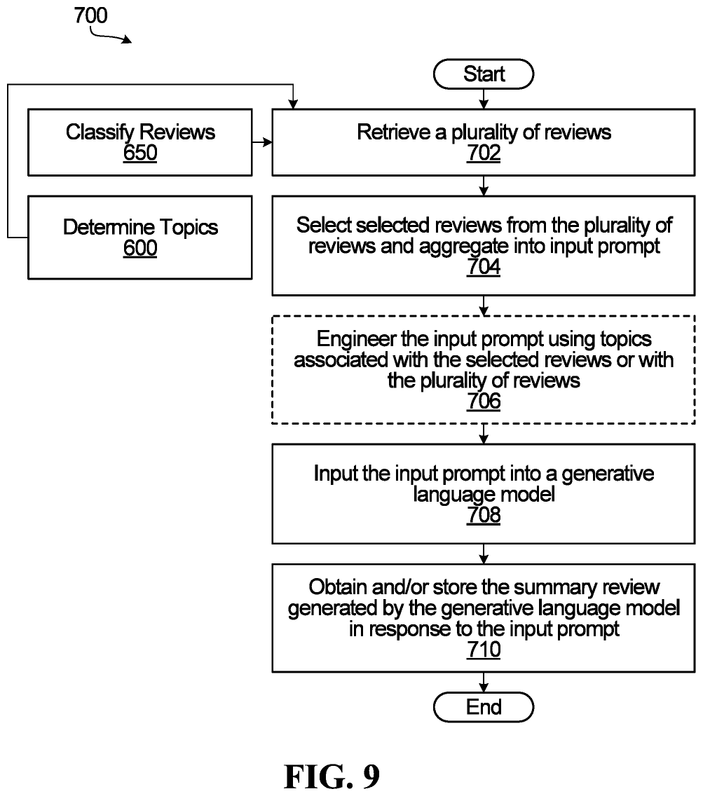

Referring now to FIGS. 5 and 9, a computer-implemented generate summary review process for utilizing a generative language model, such as an LLM described above, to generate a summary review based on an input prompt comprising selected reviews selected from a plurality of reviews based on topics associated with the plurality of reviews is generally shown at 700. Integration of an LLM may automate and standardize summarization of the selected reviews via machine-generated text. This can have technical advantages including a higher degree of quality, reliability, and standardization of machine-generated summary reviews. Additionally, in some embodiments, resulting summary reviews comprising machine-generated text that is based on both vast amounts of previously learned text and the plurality of reviews may result in standardized output that can be more easily processed by subsequent processors (e.g., such as processors implemented by the provider of the product or service and/or processors of the content server 502 for example) and/or more easily parsed and searched for by potential future users of the product or service. Further, including in an input prompt selected reviews selected from a plurality of reviews based on topics which are relevant to a particular product or service (or a category of products or services or related products or services or all products or services from a particular provider or a particular source) may allow the input prompt to include reviews which are fewer and less diverse than the entire plurality of reviews, and a summary review generated based on such an input prompt may be more directed to a relevant topic. Additionally, identifying the topics may allow the topics to be used as instructions or context in the input prompt to guide the LLM to generate a summary review which is more focused on the topics. Utilizing an input prompt including only the selected reviews or including the identified topics may improve a quality of the summary review generated by the LLM by directing the summary review towards relevant topics.

In the embodiment shown, the generate summary review process 700 is performed by the summary processor 570 executing processor, machine and/or computer readable instructions stored in the program memory 574; in other embodiments, the generate summary review process 700 may comprise processor, machine and/or computer readable instructions alternatively stored on other non-transitory computer readable storage medium; in yet other embodiments, the generate summary review process 700 and/or parts thereof could alternatively be executed by a device other than the summary processor 570, including for example, by the external model server. Further, although the generate summary review process 700 in accordance with one embodiment is described with reference to the flowchart illustrated in FIG. 9, other methods of implementing the generate summary review process 700 may alternatively be used. For example, the order of execution of the blocks may be altered, and/or some of the blocks described may be altered, eliminated, or combined.

In the embodiment shown in FIG. 9, the generate summary review process 700 begins at block 702, which may include codes directing the summary processor 570 to retrieve a plurality of reviews. In this regard, block 702 may be similar to block 602 of the determine topics process 600; however the plurality of reviews retrieved at block 702 may each be associated with no topic (e.g., associated with none of the topic labels or associated with the “no-topic” label described above), one topic (e.g., one topic label described above), or more than one topic (e.g. more than one topic label described above). For example, block 702 may direct the summary processor 570 may retrieve the plurality of reviews as a plurality of review entries from the review datastore 603 in the storage memory 572 of the summary server 506, whereby the plurality of review entries may be associated with corresponding topic entries from the topics datastore 601 in the storage memory 572 of the summary server 506. Also similar to block 602, the plurality of reviews retrieved by the summary processor 570 at block 702 may be a plurality of reviews associated with a single product or service; a plurality of reviews associated with more than one product or service, such as products or services from a category of product or service; or all possible reviews from a particular provider or from a particular source.

The generate summary review process 700 may then proceed to block 704, which may include codes directing the summary processor 570 to select selected reviews from amongst the plurality of reviews and to aggregate the selected reviews into an input prompt to be inputted into the LLM. The input prompt may be a human-readable input prompt and/or a machine-readable input prompt. The input data of the input prompt generated may include the review content and at least some of the review metadata for each review of the selected reviews. The instructions of the input prompt may include instructions to instructions to generate a summary review of the selected reviews.

In some embodiments, block 704 may direct the summary processor 570 to select the selected reviews based on relevancy values for each review of the plurality of reviews retrieved at block 702 in a manner similar to that described in U.S. patent application Ser. No. 18/467,995, titled “SUMMARY OF REVIEWS GENERATED BY A GENERATIVE LANGUAGE MODEL”, filed on Sep. 15, 2023, and incorporated herein by reference. For example, the relevancy value assigned to a review may be based on the review content associated with that review, such as an informational density of the review content, keywords within the review content may be based on the review content or a tf-idf value of the review content. The selected reviews may comprise reviews from the plurality of reviews having the highest relevancy values.

Additionally or alternatively, block 704 may also direct the summary processor 570 to select the selected reviews based on the plurality of topics which are associated with the plurality of reviews. For example, in some embodiments, the summary processor 570 may select reviews which belong to no topic of a plurality of topics associated with the plurality of reviews retrieved at block 702 (e.g., reviews associated with the “no-topic” label or with none of the topic labels). In other embodiments, the summary processor 570 may select reviews which belong to a particular topic of the plurality of topics (e.g., reviews associated with a particular topic label may be selected; utilizing the shoe product examples described above, reviews associated with the “fit” topic label may be selected). This may reduce the diversity of content in the input prompt and focus the summary review generated by the LLM on reviews directed to a known relevant topic, which may improve a quality of the generated summary review. In such embodiments, more than one input prompt may be generated for a particular plurality of reviews. For example, if three relevant topics are determined for the plurality of reviews, three different sets of selected reviews, each including reviews labelled with a particular one topic of the three topics, may be selected and aggregated at block 704. Thereafter, three different input prompts, each including a respective sets of selected reviews may be inputted into the LLM to generate different summaries for each of the three relevant topics. In yet other embodiments, the summary processor 570 may select reviews which belong to only one topic of the plurality of topics, but the one topic may be different for different reviews (e.g., continuing to utilize the shoe product examples described above, reviews associated with only the “fit” topic label may be selected and reviews associated with only the “material” topic label may also be selected). In yet other embodiments, the summary processor 570 may select reviews which belong to more than one topic, but the different topics may be defined (e.g., reviews associated with both a first topic label and with a second topic label may be selected; continuing to utilize the shoe product examples described above, the selected topics may be the “fit” topic and the “material” topic and only reviews associated with both the “fit” topic label and the “material” topic label may be selected). In yet other embodiments, the summary processor 570 may select reviews associated with more than one topic, but the more than one topic may be any different topics (e.g., reviews associated with any at least two of a first topic label, a second topic label, a third topic label and a fourth topic label may be selected; again, continuing to utilize the shoe product examples described above, reviews associated with both the “fit” topic label and the “material” topic label may be selected, reviews associated with all three of the “fit” topic label, the “material” topic label and the “design” topic label may be selected, and reviews associated with both the “fit” label and the “design” label may also be selected.

In embodiments where block 704 directs the summary processor 570 to select the selected reviews based on the topics which are associated with the plurality of reviews, block 704 may also direct the summary processor 570 to select the selected reviews based on the classification scores which are associated with the plurality of reviews. For example, in embodiments where the selected reviews are associated with one particular topic label, the summary processor 570 may select reviews from the plurality of reviews which have the highest classification scores related that particular topic. In embodiments where the selected reviews are associated with only one topic label, but the one topic label associated with different reviews may be different, the summary processor 570 may select reviews which have the highest classification scores relative to each one topic, or may select reviews which have the highest classification scores relative to one topic and the lowest classification scores relative to another topic. In embodiments where the selected reviews are associated with more than one topic label, the summary processor 570 may select reviews which have the highest classification scores relative to one topic and/or the lowest classification scores relative to another topic, the highest or the lowest summed classification scores associated with all topics of the more than one topic, or the highest or the lowest averaged classification scores associated with all topics of the more than one topic.

A number of reviews which form the selected reviews to be aggregated into the input prompt at block 704 may be based on a defined number of reviews determined in a manner similar to that described in U.S. patent application Ser. No. 18/467,995, titled “SUMMARY OF REVIEWS GENERATED BY A GENERATIVE LANGUAGE MODEL”, filed on Sep. 15, 2023, and incorporated herein by reference. In some embodiments, the defined number of reviews may be hard-coded based the input prompt limit of the LLM. In other embodiments, the defined number of reviews may have been previously determined for a particular product or service, a particular category of product or service, a plurality of products or services which are related or linked, a plurality of products or services which are provided by the same provider, etc. In some embodiments, the defined number of reviews may be determined for one product or service falling within a particular category, and then expanded to be applied for other products or services within that particular category or all products or services within that particular category. In yet other embodiments, the defined number of reviews may also be specifically determined for a particular plurality of reviews retrieved at block 702 using language embeddings generated for summary reviews generated using different numbers of reviews from the plurality of reviews.

The generate summary review process 700 then continues to optional block 706, which may include codes causing the summary processor 570 to engineer the input prompt. For example, block 706 may direct the summary processor 570 to include instructions or context in the input prompt which are directed to the plurality of topics associated with the plurality of reviews and/or the topics associated with the selected reviews. As described above, providing additional instructions or context including topics associated with the plurality of reviews or topics associated with the selected reviews can guide the LLM to improve the quality of the summary review generated by the LLM.

For example, in embodiments where the selected reviews selected and aggregated at block 704 are associated with one topic of the plurality of topics (e.g., associated with one topic label), block 706 may direct the summary processor 570 to include instructions or context related to that one topic. The instructions or context may identify the one topic, direct the LLM to generate the summary review focused on the one topic or direct the LLM to generate the summary review not focused on topics (from the plurality of topics) which are not that one topic. For example, in embodiments where the selected reviews are all reviews for product A and are directed to topic A, block 704 and 706 may cause the summary processor 570 to generate a human-readable input prompt comprising: “Here are reviews associated with product A: “review 1”, “review 2”, “review 3”[ . . . ]“review n”. These reviews are all directed to topic A. Generate a summary review summarizing the reviews and with a focus on topic A”. As an additional example, in embodiments where the selected reviews are all reviews for product A but are directed to either one of topic A or topic B, a human-readable input prompt may comprise: “Here are reviews associated with product A: “review 1”, “review 2”, “review 3”[ . . . ]“review n”. Reviews 1 and 3 are directed to topic A. Reviews 2 and n are directed to topic B. Generate a summary review summarizing the reviews and with a focus on topic A.” As an additional example, in embodiments where the selected reviews are all reviews for product A and are all directed to topic A, but where topics determined to be relevant to product A include topic A, topic B and topic C, a human-readable input prompt may comprise: “Here are reviews associated with product A: “review 1”, “review 2”, “review 3”[ . . . ]“review n”. These reviews are all directed to topic A. Topic A, topic B and topic C are relevant topics for product A. Generate a summary review summarizing the reviews and with a focus on topic A; do not mention topic B or topic C in the summary review.” Additionally or alternatively, block 706 may cause the summary processor 570 to generate a machine-readable input prompt comprising: “prompt”: {“<product A review 1, review content, review metadata, topic A>, <product A review 2, review content, review metadata, topic A>, <product A review 3, review content, review metadata, topic A>[ . . . ]<product A review n, review content, review metadata, topic A>”, “completion”=“generate a summary review based on the reviews above having a focus on topic A”}

Additionally or alternatively, in embodiments where the selected reviews are associated with more than one topic of the plurality of topics (e.g., associated with more than one topic label), block 706 may direct the summary processor 570 to include instructions or context related to the more than one topic. For example, the instructions or context may identify the more than one topic, direct the LLM to focus on the more than one topic, direct the LLM to focus on one topic of the more than one topic over another topic of the more than one topic, direct the LLM to not focus on topics which are not the more than one topic. For example, in embodiments where the selected reviews are all reviews for product A and are all directed to both topic A and topic B, a human-readable input prompt may comprise: “Here are reviews associated with product A: “review 1”, “review 2”, “review 3”[ . . . ]“review n”. These reviews are all directed to topic A and topic B. Generate a summary review summarizing the reviews and with a focus on topic A and less focus on topic B (or a focus on topic B and less focus on topic A).” Alternatively, the human-readable input prompt may instead comprise: “Here are reviews associated with product A: “review 1”, “review 2”, “review 3”[ . . . ]“review n”. These reviews are all directed to topic A and topic B. Generate a summary review summarizing the reviews and with a focus on topic A and topic B.” As an additional example, in embodiments where the selected reviews are all reviews for product A and are all directed to topics A and B, but where topics determined to be relevant to product A include topic A, topic B and topic C, a human-readable input prompt may comprise: “Here are reviews associated with product A: “review 1”, “review 2”, “review 3”[ . . . ]“review n”. These reviews are all directed to topic A and topic B. Topic A, topic B and topic C are relevant topics for product A. Generate a summary review summarizing the reviews and with a focus on topics A and B; do not mention topic C in the summary review.” Additionally or alternatively, block 706 may cause the summary processor 570 to generate a machine-readable input prompt comprising: “prompt”: {“<product A review 1, review content, review metadata, topic A, topic B>, <product A review 2, review content, review metadata, topic A, topic B>, <product A review 3, review content, review metadata, topic A, topic B>[ . . . ]<product A review n, review content, review metadata, topic A, topic B>”, “completion”=“generate a summary review based on the reviews above having a focus on topic A and less focus on topic B”}

Additionally or alternatively, in embodiments where the selected reviews are associated with no topic of the plurality of topics (e.g., associated with a “no-topic” label or associated with none of the topic labels), block 706 may direct the summary processor 570 to include instructions or context related to the plurality of topics which are associated with the plurality of reviews. For example, the instructions or context may identify the plurality of topics and identify how the selected reviews are not associated with any topic of the plurality of topics. For example, in embodiments where the selected reviews are all reviews for product A and are not directed to any topic, and where topics determined to be relevant to product A include topic A, topic B and topic C, a human-readable input prompt may comprise: “Here are reviews associated with product A: “review 1”, “review 2”, “review 3”[ . . . ]“review n”. These reviews are not directed to any known topic relevant for product A. Topic A, topic B and topic C are relevant topics for product A. Generate a summary review summarizing the reviews; identify a topic different from topic A, topic B or topic C in the summary review.” Additionally or alternatively, block 706 may cause the summary processor 570 to generate a machine-readable input prompt comprising: “prompt”: {“<product A review 1, review content, review metadata, no topic>, <product A review 2, review content, review metadata, no topic >, <product A review 3, review content, review metadata, no topic>[ . . . ]<product A review n, review content, review metadata, no topic >”, “completion”=“generate a summary review based on the reviews above; identify a topic different from topics A, topic B or topic C in the summary review”}

The generate summary review process 700 then continues to block 708, which may include codes causing the summary processor 570 to input the input prompt comprising at least the selected reviews selected at block 704 (and potentially the context and/or instructions generated at block 706) into the LLM and yielding a summary review of the selected reviews generated by the LLM.

The generate summary review process 700 may then continue to block 710, which may include codes causing the summary processor 570 to transmit and/or store the summary review generated by the LLM. For example, the summary review may be stored as a summary review entry in the summary review datastore 605. In some embodiments, the summary review entry may be stored in association with at least one of: the product or service for which the plurality of reviews retrieved at block 702 is directed to, a category of product or service for which the plurality of reviews retrieved at block 702 is directed to, the plurality of reviews retrieved at block 702, the plurality of topics associated with the plurality of reviews retrieved at block 702, the selected reviews selected and aggregated at block 704, the topics associated with the selected reviews selected and aggregated at block 704. Additionally or alternatively, the summary review may also be transmitted to one or more of the content server 502 and/or the client devices 504. In some embodiments, the content server 502 may display the summary review associated with a particular product or service in the content associated with the product or service hosted by the content server 502. For example, referring briefly back to FIG. 4, the content server 502 may display a summary review of the software application 554 generated by the LLM on the webpage 552. The generate summary review process 700 then ends.

### Alternative Method 750

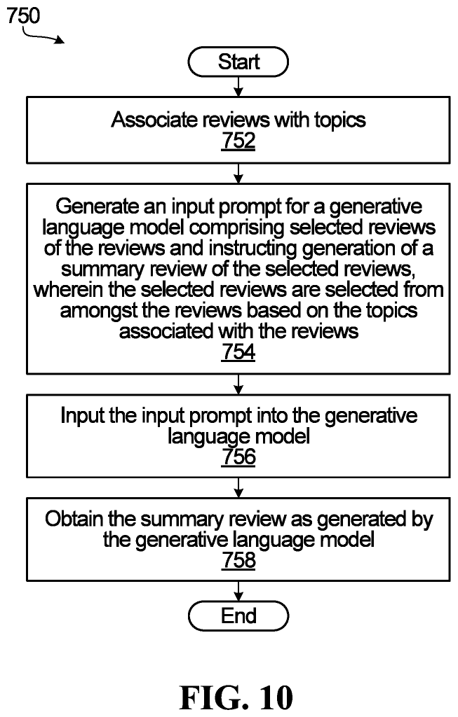

Referring to FIGS. 5 and 10, an alternative computer-implemented method to generate a summary review based on an input prompt comprising selected reviews selected from reviews based on topics associated with the reviews is generally shown at 750. In the embodiment shown, the method 750 is performed by the summary processor 570 executing processor, machine and/or computer readable instructions stored in the program memory 574. In other embodiments, the method 750 may comprise processor, machine and/or computer readable instructions alternatively stored on other non-transitory computer readable storage medium such as a CD-ROM, a floppy disk, a hard drive, a DVD, a Blu-ray disk or another component associated with the summary server 506; in yet other embodiments, the method 750 and/or parts thereof could alternatively be executed by a device other than the summary processor 570, including for example, by the client devices 504. Further, although the method 750 in accordance with one embodiment is described with reference to the flowchart illustrated in FIG. 10, other methods of implementing the method 750 may alternatively be used. For example, the order of execution of the blocks may be altered, and/or some of the blocks described may be altered, eliminated, or combined.

At block 752, the summary server 506 may associate reviews with topics. The reviews may comprise a plurality of reviews associated with a single product or service, a plurality of reviews associated with more than one product or service (e.g., products or services from a category of product or service and/or a plurality of related products or services), or a plurality of reviews associated with all products or services from a particular provider or a particular source (e.g., reviews associated with all products or services hosted on a particular e-commerce platform), and may be retrieved in a manner similar to block 602 of the determine topics process 600 described above.

The topics may comprise a plurality of topics which are retrieved in a manner similar to block 604 of the determine topics process 600 described above, and may be topics known to be relevant for a particular product or service, a particular category of products or services, related products or services, or all products or services from a particular provider or a particular source. In such embodiments, reviews may be associated with different topics of the retrieved plurality of topics based on keywords or keydata in the review content and/or the review metadata of the reviews in a manner similar to block 606 of the determine topics process 600.

The topics may also comprise a plurality of topics which are generated in a manner similar to block 610 of the determine topics process 600, and may be generated based on review content and/or review metadata of the plurality of reviews directed to a particular product or service, a particular category of products or services, related products or services, or all products or services from a particular provider or a particular source. For example, in some embodiments, block 752 may direct the summary processor 570 to generate semantic vectors of the reviews. For example, the summary processor 570 may use different text embedding processes and models known to one of ordinary skill in the art and in a manner similar to subblock 612 of the determine topics process 600. Block 752 may then direct the summary processor 570 to cluster, using at least one clustering process, the reviews into topic clusters based on the semantic vectors, wherein the topic clusters correspond to the topics. The reviews may be clustered into a plurality of topic clusters using a variety of different clustering processes known to one of ordinary skill in the art and in a manner similar to subblock 614 of the determine topics process 600. The different topic clusters generated by the at least one clustering process may correspond to different topics to be associated with the reviews. The number and identity of topic clusters generated for the plurality of reviews may correspond to the number and identity of topics to be associated with that the plurality of reviews. In such embodiments, reviews may be associated with different topics of the generated plurality of topics based on whether the review is clustered into a corresponding topic cluster by the at least one clustering process in a manner similar to subblock 614 of the determine topics process 600.

In some embodiments, the summary server 506 may associate the reviews with the topics by classifying the reviews according to the topics using a review classifier in a manner similar to the classify review process 650. The review classifier may be a ML model trained by inputting training pairs of training reviews which are ground labelled with training topic labels, for example, to iteratively generate and optimize coefficients which enable the review classifier to generate an output of a topic label based on an input of a review. In such embodiments, the summary server 506 may create a review training set of training pairs, the training pairs paring training topic labels with training reviews. In some embodiments, the training reviews may comprise the plurality of reviews retrieved by summary server 506; the training topic labels may correspond to the plurality of topics retrieved by the summary server 506; and the pairing between the training topic labels and corresponding ones of the training reviews may be based on the determination of which reviews should be associated with which topics based on keywords or keydata in the review content and/or the review metadata of the reviews. In other embodiments, the training reviews may comprise the plurality of reviews retrieved by summary server 506; the training topic labels may correspond to the plurality of topics generated by the summary server 506 by the at least one clustering process; and the pairing between the training topic labels and corresponding ones of the training reviews may be based on the determination of which topic cluster(s) a review is classified into.

The summary server 506 may also generate a classification score of the association of topics with reviews. For example, the summary server 506 may generate high classification scores for a review for a particular topic when the review includes a large number of keywords or keydata of the particular topic. As an additional example, summary server 506 may generate high classification scores for a review for a particular topic when the review is close to a centre of a topic cluster corresponding to the particular topic.

At block 754, the summary server 506 may generate an input prompt for a generative language model (e.g., an LLM as described above). The input prompt may comprise selected reviews of the reviews, the selected reviews selected from amongst the reviews based on the topics associated with the reviews. For example, the summary server 506 may select reviews which are associated with no topic of the topics, may select reviews which are associated with a particular topic of the topics, or may select reviews are associated with more than one topic of the topics in a manner similar to block 704 of the generate summary review process 700.

The input prompt may also instruct generation of a summary review of the selected reviews. The input prompt may also include instructions or context identifying the topics associated with the reviews and/or the topics associated with the selected reviews. For example, in embodiments where the selected reviews in the input prompts are associated with no topic of the topics, the input prompt may include instructions or context identifying all of the topics, in a manner similar to block 706 of the generate summary review process 700. Additionally or alternatively, in embodiments where the selected reviews in the input prompts are associated with one topic of the topics, the input prompt may include instructions or context identifying the one topic in a manner similar to block 706 of the generate summary review process 700 and the selected reviews may be selected from amongst the reviews based on a classification score of the selected reviews relative to the one of the topics in a manner similar to block 704 of the generate summary review process 700. Additionally or alternatively, in embodiments where the selected reviews in the input prompts are associated with at least two topics of the topics, the input prompt may include instructions or context identifying the at least two of the topics in a manner similar to block 706 of the generate summary review process 700 and the selected reviews may be selected from amongst the reviews based on at least one of an averaged classification score or a summed classification score of the reviews relative to the at least two of the topics in a manner similar to block 704 of the generate summary review process 700.

At block 756, the summary server 506 may input inputting the input prompt into the generative language model. At block 758, the summary server 506 may obtain, from the generative language model, the summary review as generated by the generative language model.

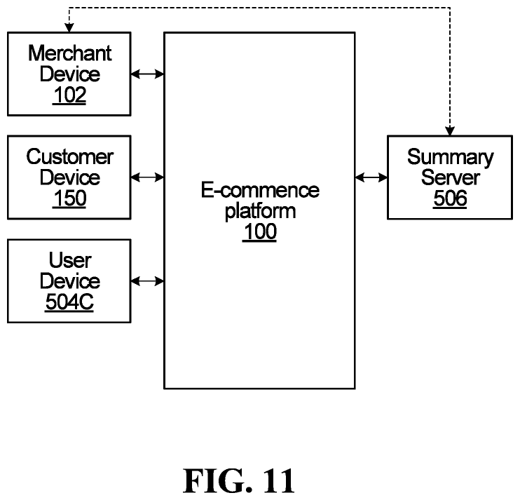

FIG. 11 illustrates an example in which the components of the software platform 500 of FIG. 3 comprise components of a commerce platform, whereby the content server 502 of FIG. 3 comprises an e-commerce platform 100, whereby the e-commerce platform 100 may host content including a plurality of reviews. The client devices 504 may include a customer device 150 and a merchant device 102. However, the methods described herein need not be limited to e-commerce because many platforms outside of e-commerce have computer systems which may host content including a plurality of reviews.

### Conclusion

While specific embodiments have been described and illustrated, such embodiments should be considered illustrative of the subject matter described herein and not as limiting the claims as construed in accordance with the relevant jurisprudence.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g., read-only-memory (ROM) or a disk), or memory that is volatile (e.g., random access memory (RAM)). The memory may be distributed, e.g., a same memory may be distributed over one or more servers or locations.

1. A computer-implemented method comprising:
associating reviews with topics;
generating an input prompt for a generative language model, the input prompt comprising selected reviews of the reviews, the selected reviews selected from amongst the reviews based on the topics associated with the reviews and instructing generation of a summary review of the selected reviews;
inputting the input prompt into the generative language model; and
obtaining, from the generative language model, the summary review as generated by the generative language model.

2. The computer-implement method of claim 1, wherein associating the reviews with the topics comprises:
generating semantic vectors of the reviews; and
clustering, using one or more clustering processes, the reviews into topic clusters based on the semantic vectors, wherein the topic clusters correspond to the topics.

3. The computer-implemented method of claim 1, wherein associating the reviews with the topics comprises:
classifying, using a review classifier, the reviews according to the topics.

4. The computer-implemented method of claim 3, further comprising training the review classifier by:
creating a review training set of training pairs, the training pairs paring training topic labels with training reviews, wherein the training topic labels correspond to the topics; and
training the review classifier using the review training set.

5. The computer-implemented method of claim 4, further comprising generating the training topic labels by:
generating semantic vectors for the training reviews; and
clustering, using one or more clustering processes, the training reviews into training topic clusters based on the semantic vectors, wherein each of the training topic clusters corresponds to one of the training topic labels.

6. The computer-implemented method of claim 1, wherein the reviews are associated with the topics based on text content of the reviews.

7. The computer-implemented method of claim 1, wherein the selected reviews include reviews associated with one of the topics and wherein the input prompt further includes instructions or context identifying the one of the topics.

8. The computer-implemented method of claim 7, wherein the selected reviews are selected from amongst the reviews further based on a classification score of the selected reviews relative to the one of the topics.

9. The computer-implemented method of claim 1, wherein the selected reviews include reviews associated with at least two of the topics, and wherein the input prompt further includes instructions or context identifying the at least two of the topics.

10. The computer-implemented method of claim 9, wherein the selected reviews are selected from amongst the reviews further based on at least one of an averaged classification score or a summed classification score of the reviews relative to the at least two of the topics.

11. The computer-implemented method of claim 1, wherein the selected reviews include reviews associated with none of the topics and wherein the input prompt further comprises instructions or context identifying the topics.

12. The computer-implemented method of claim 1, wherein generating the input prompt further comprises:
determining sets of selected reviews of the reviews, wherein a set of selected reviews of the sets of selected reviews is associated with a corresponding topic of the topics; and
generating input prompts, wherein one input prompt of the input prompts include the set of selected reviews and instructions or context identifying the corresponding topic.

13. A system comprising:
at least one processor; and
a memory storing processor-executable instructions that, when executed, cause the at least one processor to:
associate reviews with topics;
generate an input prompt for a generative language model, the input prompt comprising selected reviews of the reviews, the selected reviews selected from amongst the reviews based on the topics associated with the reviews, and instructing generation of a summary review of the selected reviews;
input the input prompt into the generative language model; and
obtain, from the generative language model, the summary review as generated by the generative language model.

14. The system of claim 13, wherein the processor-executable instructions which cause the at least one processor to associate the reviews with the topics comprises processor-executable instructions which cause the at least one processor to:
generate semantic vectors of the reviews; and
cluster, using one or more clustering processes, the reviews into topic clusters based on the semantic vectors, wherein the topic clusters correspond to the topics.

15. The system of claim 13, wherein the processor-executable instructions which cause the at least one processor to associate the reviews with the topics comprises processor-executable instructions which cause the at least one processor to:
classify, using a review classifier, the reviews according to the topics.

16. The system of claim 15, wherein the processor-executable instructions further cause the at least one processor to train the review classifier by causing the at least one processor to:
create a review training set of training pairs, the training pairs paring training topic labels with training reviews, wherein the training topic labels correspond to the topics; and
train the review classifier using the review training set.

17. The system of claim 13, wherein the selected reviews include reviews associated with one of the topics and wherein the input prompt further includes instructions or context identifying the one of the topics.

18. The system of claim 13, wherein the selected reviews include reviews associated with at least two of the topics, and wherein the input prompt further includes instructions or context identifying the at least two of the topics.

19. The system of claim 13, wherein the selected reviews include reviews associated with none of the topics and wherein the input prompt further comprises instructions or context identifying the topics.

20. A non-transitory computer-readable storage medium having stored thereon processor-executable instruction that, when executed, cause at least one processor to:
associate reviews with topics;
generate an input prompt for a generative language model, the input prompt comprising selected reviews of the reviews, the selected reviews selected from amongst the reviews based on the topics associated with the selected reviews, and instructing generation of a summary review of the selected reviews;
input the input prompt into the generative language model; and
obtain, from the generative language model, the summary review as generated by the generative language model.
